(19) United States
(12) Patent Application Publication
(10) Pub. No.: US 2005/0173226 A1
(43) Pub. Date: Aug. 11, 2005

(54) Conveyor lift

(76) Inventors: Derek Lawrence Gold, Meysey Hampton (GB); Henry Gerald Mutkin, London (GB); Christopher John Page, Cheltenham (GB); Graham Gold, Stanmore (GB)

Correspondence Address: KENYON & KENYON, ONE BROADWAY, NEW YORK, NY, 10004, US

(21) Appl. No.: 10/451,571

(22) PCT Filed: Nov. 22, 2001
(86) PCT No.: PCT/GB01/05146

(30) Foreign Application Priority Data
Nov. 24, 2000 (GB) 0028680.7
Jan. 22, 2001 (GB) 0101560.1

(51) Int. Cl. B65G 37/00

(52) U.S. Cl. 198/570

(57) ABSTRACT

A conveyor lift having a device for engaging a product to transfer the product from a conveyor at one level to a conveyor at another level wherein the lift is driven by at least one drive comprising a motor, and a coupling to couple the motor to the lift wherein the coupling comprises a clutch comprising a pair of drive members which are relatively rotatable about, and axially movable along, an axis, a relievable biasing device to bias the drive members axially towards each other so as to be disengageably connected in torque transmitting relationship and a relieving element operable to release the biasing device to interrupt transmission of said torque and the coupling also incorporating a torque indicating device comprising first and second torque transmitting parts, torque transmitting elements connecting said first and second parts, the device being rotatable about the axis and having torque sensing apparatus on at least one of said torque transmitting elements and responsive to torque transmitted by said torque transmitting apparatus to provide a signal dependent upon said transmitted torque.

### DESCRIPTION OF INVENTION

This invention relates to a conveyor lift having a device for engaging a product to transfer the product from a conveyor at one level to a conveyor at another level.

Plants, for example motor vehicle assembly plants, may have a conveyor at one level and a conveyor at another level and such a conveyor lift for transferring a car body panel or other product between the conveyors.

The conveyor lift may be driven by a main drive which has a motor, usually a gearbox, and a coupling to couple the motor to the lift. The motor, gearbox when provided and coupling may be duplicated to provide an auxiliary drive if desired, to give a reserve or alternative drive for the conveyor lift, for example, in the case of a failure of the main drive.

Downtime of the conveyor lift leads to costly loss of production and even a changeover from the main drive to the auxiliary drive takes a relatively long time typically approximately 1 hour and such changeover requires the conveyor lift and the associated production line to be at a standstill during the changeover time.

An object of the invention is to provide a new and improved conveyor lift whereby the above mentioned problems are overcome or are reduced.

According to a first aspect of the present invention we provide a conveyor lift having a device for engaging a product to transfer the product from a conveyor at one level to a conveyor at another level wherein the lift is driven by at least one drive comprising a motor, and a coupling to couple the motor to the lift wherein the coupling comprises a clutch comprising a pair of drive members which are relatively rotatable about, and axially movable along, an axis, a relievable biasing device to bias the drive members axially towards each other so as to be disengageably connected in torque transmitting relationship and a relieving apparatus operable to release the biasing device to interrupt transmission of said torque and the coupling also incorporating a torque indicating device comprising first and second torque transmitting parts, torque transmitting elements connecting said first and second parts, the device being rotatable about the axis and having torque sensing apparatus on at least one of said torque transmitting elements and responsive to torque transmitted by said torque transmitting element to provide a signal dependent upon said transmitted torque.

Said signal may be transmitted to a receiving apparatus by means of a slip ring between the torque indicating device and a fixed element.

Alternatively, the torque transmitting device may be provided with a communicating apparatus including a transmitter of electromagnetic radiation receiving said signal produced by said torque sensing apparatus and communicating an output signal dependent upon said torque to receiving apparatus which provides an output responsive to said transmitted torque.

The first part of the torque indicating device may comprise a radially inner part, relative to said axis, and the second part comprises a radially outer part, relative to said axis and the torque transmitting elements comprise at least one radially and circumferentially extending torque transmitting element extending between said parts to transmit torque therebetween.

The electromagnetic radiation may be of radio frequency and be transmitted from an aerial to the receiving means.

The drive members may be disengageably connectable in torque transmitting relationship by a plurality of torque transmitting elements interposed between the drive members and which are biased into torque transmitting relationship with torque transmitting abutments by the biasing means when the clutch is engaged and which are moveable out of torque transmitting relationship with a torque transmitting abutments.

The torque transmitting elements of the clutch may be rotatable and are guided by a cage which is free to rotate relative to both drive members during disengagement and there are provided:
a) means to maintain the cage space further from one of said drive members when the clutch is disengaged than when the clutch is engaged, and
b) a guide member biasing means to remove the guide members apart when the clutch is disengaged to provide a separation between the parts of the drive members which are engaged by the torque transmitting elements which is greater than the diameter of the torque transmitting elements
   to maintain the torque transmitting elements out of engagement with the torque transmitting abutment of said one drive member when the clutch is disengaged.

The clutch may be a torque limiting clutch and said movement of the torque transmitting elements out of out torque transmitting relationship may occur when the torque exceeds a predetermined value and is as a result of movement of the drive members axially apart by the torque transmitting elements and the relieving means relieves the biasing means when the torque exceeds the predetermined value.

The conveyor lift may have a control means for managing the relief of said biasing devices or devices based on transmitted torque.

The lift may be provided with a main drive and an auxiliary drive each of which comprises a motor and a coupling to couple the motor to the lift.

The main drive and the auxiliary drive may each be in accordance with any one of the preceding statements of invention.

The relieving means of one of said clutches may be actuated to cause the clutch not to transmit torque when the torque indicating device of the coupling comprising said one clutch senses a predetermined torque and the relieving means of the other of said clutches may be de-activated to cause said other clutch to transmit torque.

A control apparatus may be provided alternately to activate one of said drives to cause it not to transmit torque to the lift and de-activate the other of said drives to cause it to transmit torque to the lift.

The control apparatus may be manually operable.

The control apparatus may be automatically operated on the basis of the time for which each of said drives has been activated.

The biasing means may comprise air pressure means and the relieving means comprises means to relieve said air pressure.

Alternatively, the biasing means may comprise a spring means and the relieving means comprise air pressure means.

According to another aspect of the invention we provide a method of operating a conveyor lift according to the first aspect of the invention comprising performing a step selected from the group comprising:
a) wherein the clutch is a torque limiting clutch and relative movement of said drive members when the transmitted torque exceeds a predetermined value causes operation of the said relieving apparatus,
b) wherein the conveyor lift is provided with a main drive and an auxiliary drive each of which comprises a motor and a coupling to couple the motor to the lift wherein a control device is provided wherein the relieving apparatus of one of said clutches is actuated to cause the clutch not to transmit torque when the torque indicating device of the coupling comprising said one clutch senses a predetermined torque and the relieving apparatus of the other of said clutches is de-activated to cause said other clutch to transmit torque,
c) wherein the lift is provided with a main drive and an auxiliary drive each of which comprises a motor and a coupling to couple the motor to a lift and said control device is operated alternately to de-activate one of said relieving apparatus to cause it to transmit torque to the lift and to deactivate the other of said relieving apparatus to cause it not to transmit torque to the lift,
d) the control device referred in c) may be a manually operable device or may be operable depending upon the time for which each drive has been operating,
e) a predetermined torque may be indicated by the torque indicating apparatus,
f) where the lift is provided with a main drive an auxiliary drive each of which comprises a motor and a coupling to couple the motor to the drive the coupling may be arranged to changeover the drive from the main drive motor to the auxiliary drive motor or vice versa at a predetermined torque,
g) the torque indicating device may provide a signal in accordance with a predetermined torque so that a maintenance operative may investigate the drive showing said predetermined torque and may cause a changeover of the drive from said one drive to the other drive.
h) apparatus may be provided to monitor the condition of the or each drive and/or of the lift by sensing a variation in torque.
i) apparatus may be provided to record the variation in torque of the or each drive in any desired manner using the output of the torque indicating device.

A conveyor lift in accordance with the present invention enables the drive to be manually controlled so as to either drive or not drive as desired and therefore a change from the main drive motor to the auxiliary drive motor and vice versa can be made simply by actuating the relieving apparatus of the coupling where drive is not required to be transmitted and de-activating the relieving apparatus of the coupling where drive is to be transmitted.

Any abnormal change in torque is indicated by the torque sensing apparatus and then if desired, where an alternative drive is provided, the coupling may be arranged to changeover the drive from the main drive motor to the auxiliary drive motor or vice versa at a predetermined torque value.

In addition or alternatively a signal may be provided so that a maintenance operative may investigate the drive showing an abnormal torque before failure thereof and/or if desired before changeover to the other motor.

The couplings may be arranged so that the drive motors are operated alternatively without losing any time in the changeover.

If desired the condition of the drive and/or of the lift may be monitored by sensing a variation in, or a predetermined, torque using the torque sensing apparatus.

A user may record any variation in torque in any desired manner by using the output from the torque sensing apparatus.

If a predetermined torque level occurs then the drive is protected against this by the provision of the above mentioned coupling as a torque limiting coupling.

Embodiments of the invention will now be described by way of example with reference to the accompanying drawings wherein:—

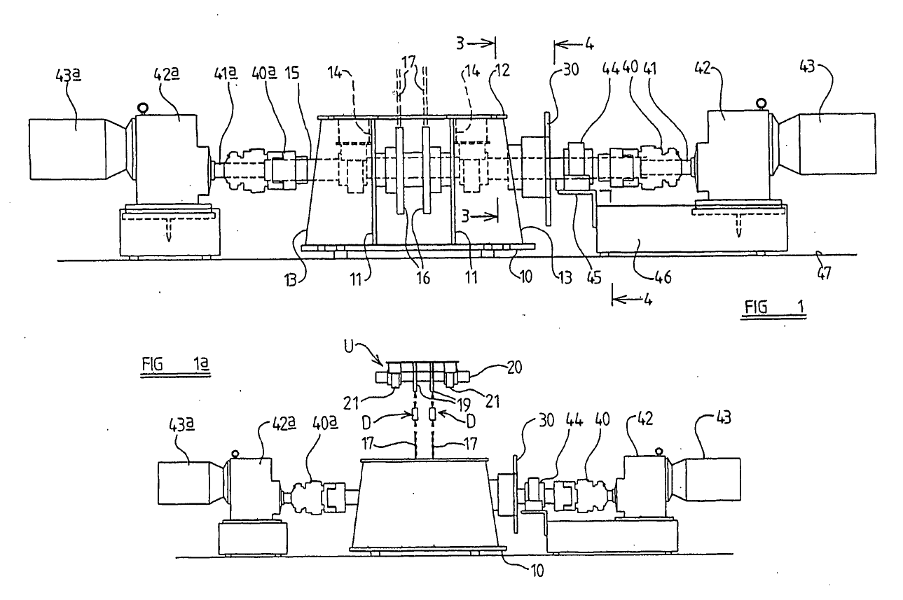

FIG. 1 is a side view of a lower part of a conveyor lift embodying the invention,

FIG. 1a is a diagrammatic view of a conveyor lift embodying the invention,

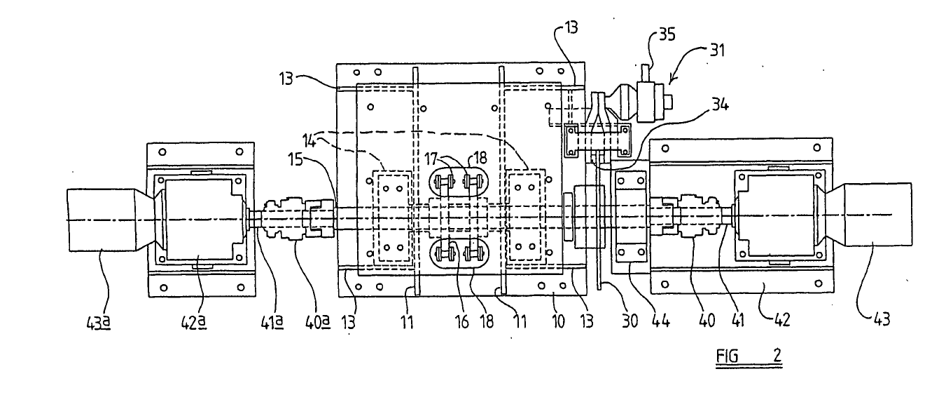

FIG. 2 is a plan view of the arrangement shown in FIG. 1,

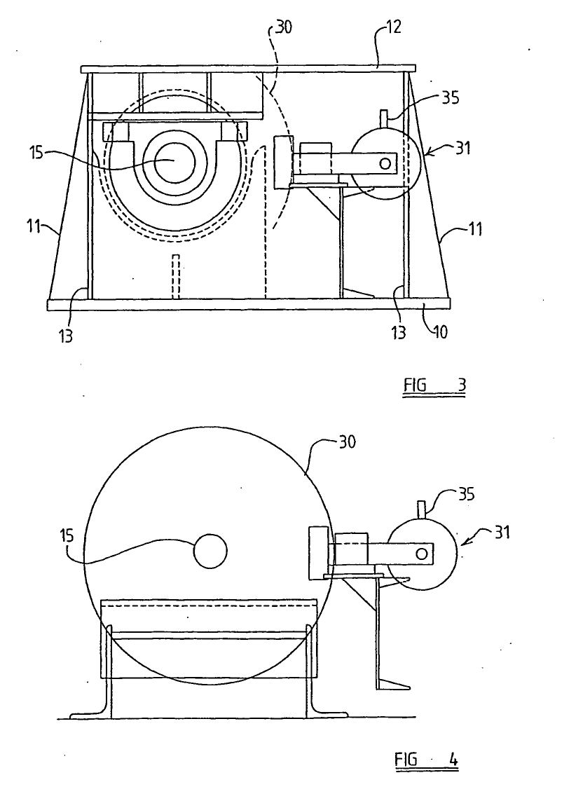

FIG. 3 is an end view on the line 3-3 of FIG. 1,

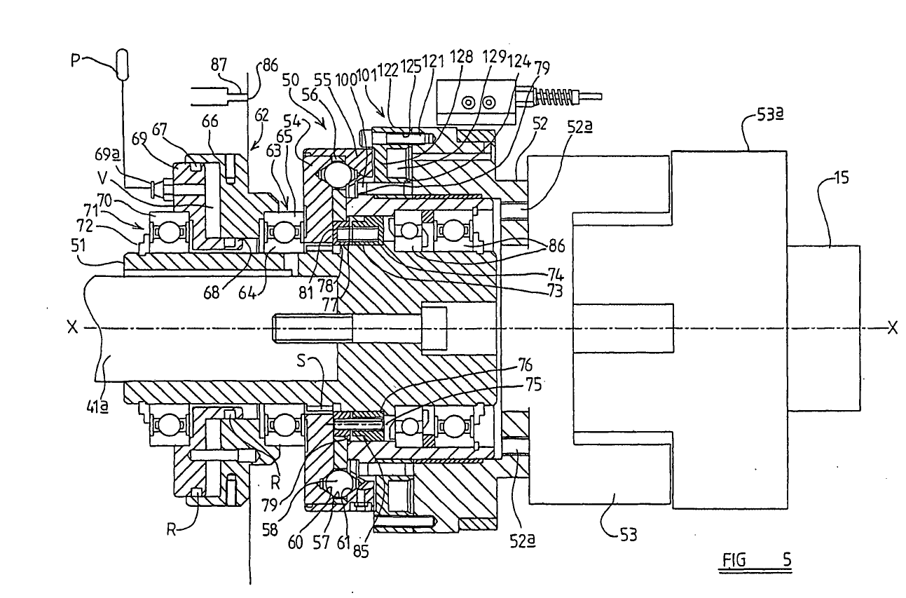

FIG. 4 is a view on the line 4-4 of FIG. 1,

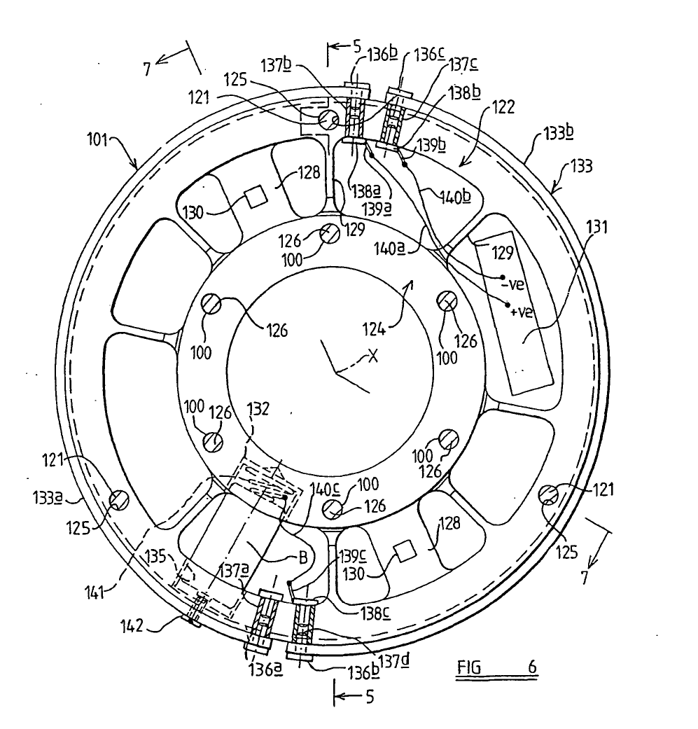

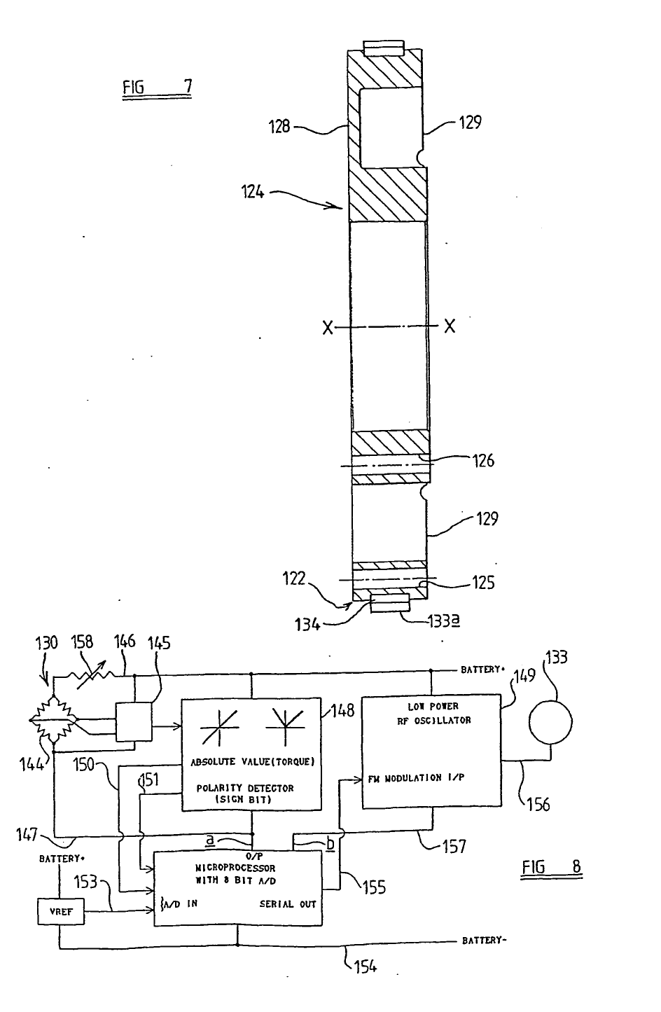

FIG. 5 is a vertical cross-sectional view of a coupling used in the lift shown in FIG. 1-4, taken on the longitudinal axis thereof and on the line 5-5 of FIG. 6,

FIG. 6 is an axial view of the torque indicating device of FIGS. 1-5,

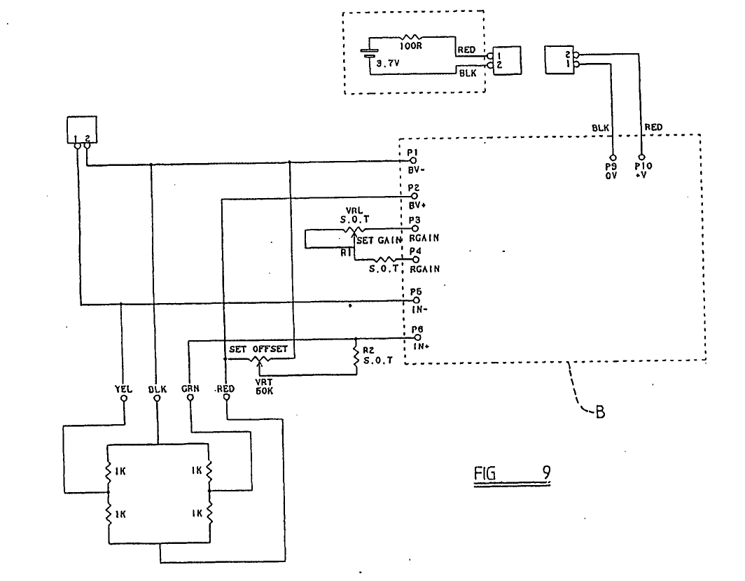

FIG. 7 is a section on the line 7-7 of FIG. 6,

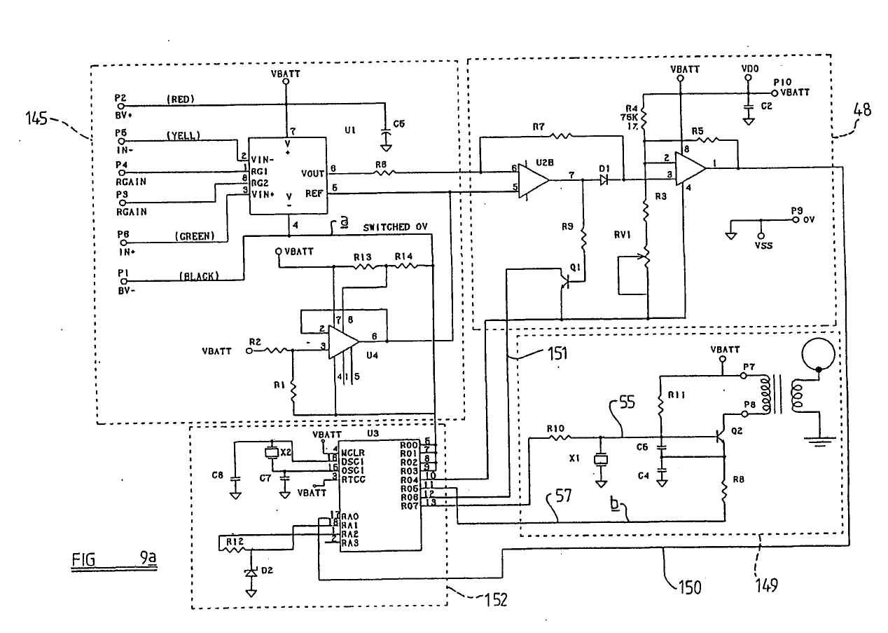

FIG. 8 is a block circuit diagram of a torque communicating device of FIGS. 1 to 7,

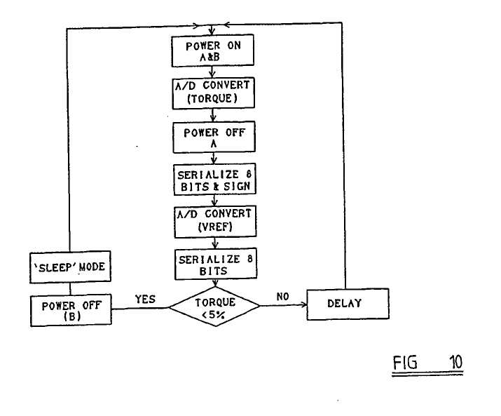

FIG. 9 is a circuit diagram in respect of the torque communicating device of FIG. 1 to 7,

FIG. 9a is a circuit diagram showing part B of FIG. 9 in more detail,

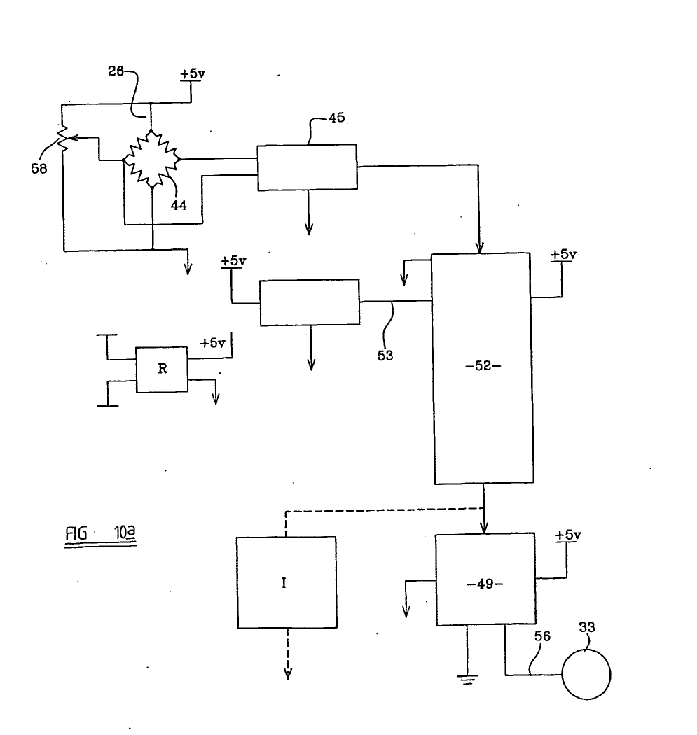

FIG. 10 is a flow chart which illustrates the cycle of the torque communicating device of FIGS. 1 to 9a.

FIG. 10a is a circuit diagram in respect of a modification of the circuit diagram shown in FIG. 9,

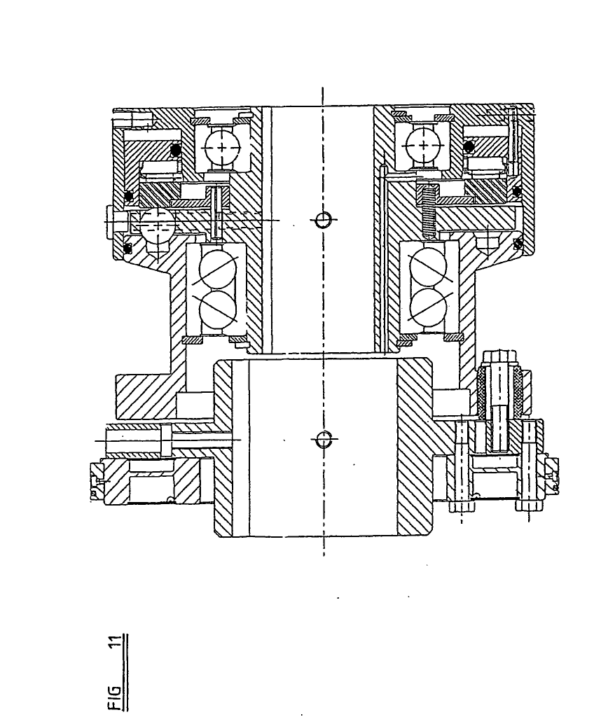

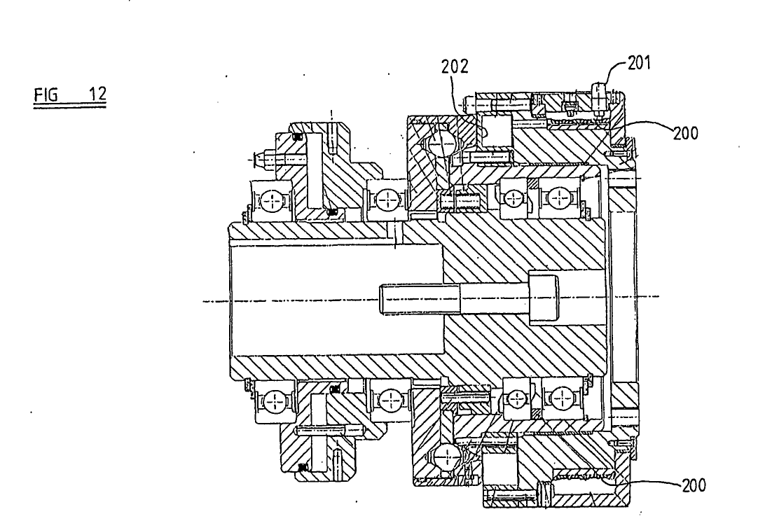

FIGS. 11 and 12 are longitudinal sectional views through alternative arrangements of coupling for use in the conveyor lift described with reference to FIGS. 1 to 10,

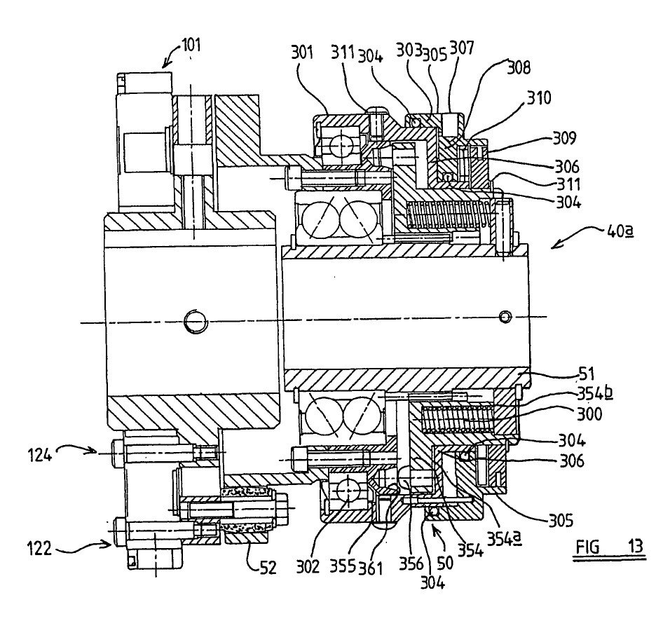

FIG. 13 is a longitudinal sectional view of a further alternative coupling for use in the conveyor lift of FIGS. 1 to 4.

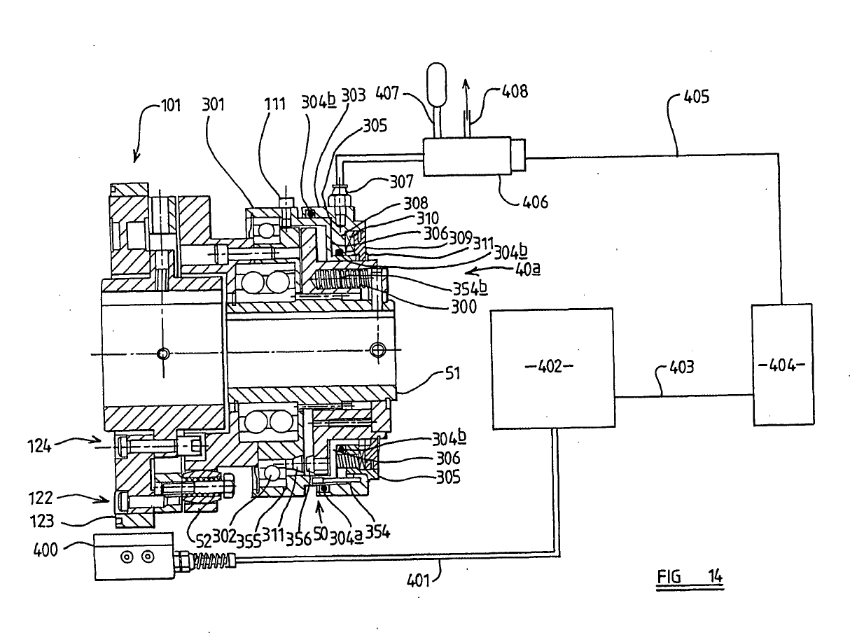

FIG. 14 is a longitudinal sectional view of a still further coupling for use in the conveyor lift of FIGS. 1 to 4.

Referring to the figures, a vertical drop lift is shown for transporting a motor vehicle body from a conveyor disposed at a one, lower, level to a conveyor disposed at another, higher level.

As best shown in FIGS. 1 and 2 a lower sub-assembly comprises a frame 10 from which a pair of upright plates 11 extend upwards and support an upper plate 12. Four trapezoidal plates 13 are provided to brace the frame 10, plates 11 and plate 12.

Bolted to the underside of the plate 12 are a pair of pillow blocks 14 by which a drive shaft 15 is rotatably supported. The drive shaft 15 has fixed to rotate therewith a pair of sprockets 16 around which are entrained roller link chains 17 which emerge in a vertical direction through generally oval-shaped openings 18 provided in the plate 12 and which are entrained, at their upper end, about a further pair of sprockets 19 carried by an upper shaft 20 rotatably mounted on pillow blocks 21 of an upper sub-assembly U. The roller link chains 17 are provided with at least one device D for engaging a product such as a car body, to be lifted. The device D is shown only diagrammatically and in use will be shaped as necessary to engage the product concerned.

The shaft 15 has fixed thereto a brake disc 30 with which a pair of callipers of a spring actuated calliper brake 31 are engaged, the brake pads of the calliper being indicated at 34. An air supply 35 is supplied to the brake 31 so as to hold the pads 34 out of braking engagement with the disc 30 and which is interrupted to allow spring application of the brake and thus rapid halting of the lift and in particular to prevent reversal of the lift and downward movement of a car body or other product carried thereby.

The shaft 15 is connected by a coupling device 40, hereinafter described in more detail, to an output shaft 41 of a gearbox 42 driven by a main drive electric motor 43. Shaft 15 is also connected by a further coupling device 40a to an output shaft 41a of a gearbox 42a of an auxiliary drive electric motor 43a.

Because of the distance between the pillow block 14 disposed between the brake and the sprockets 16 and the gearbox 42 an additional pillow block 44 is provided for the shaft 15 carried on a bracket 45 mounted on a block 46 whereby the motor 42 is supported above a base level 47.

Referring now to FIG. 5 each coupling 40, 40a is identical and thus only the coupling 40a will be described and illustrated in detail in FIG. 5. The coupling 40a comprises a torque limiting clutch, indicated generally at 50 to connect the output shaft 41a of the auxiliary gearbox 42a with the shaft 15. The clutch 50 comprises a driving member 51 and a driven member 52. The driving member 51 is connected by a splined connection to the output shaft 41a whilst the driven member 52 is connected by suitable bolts 52a to an element coupling 53 which is splined to a flange 53a fastened to an end part of the shaft 15.

The driving member 51 has a driving clutch plate 54 splined thereto as shown at S for axial sliding and non-rotatable movement relative to the driving member 51. The driving clutch plate 54 is connected in torque transmitting relationship with a driven clutch plate 55. Interposed therebetween is a cage plate 56 which has a plurality of apertures 57 therein for torque transmitting elements in the form of balls 58. The apertures 57 are of generally cylindrical configuration but are provided with smaller ends at the end thereof adjacent the driven clutch plate 55.

The thickness of the cage plate 56 relative to the diameter of the balls 58 is such that the smaller diameter end of the apertures 57 nearly engages the balls 58 as shown when the clutch is engaged i.e. on a chord approximately midway between the centre of the ball and its surface.

The driving and driven clutch plates 54, 55 are provided with torque transmitting abutments 60, 61 respectively which are in the form of generally frusto-conical recesses having an included angle of approximately 70°. If desired other angles may be used, for example 90°, but a smaller angle such a 70° is preferred because this permits transmittal of a greater torque between the clutch plates for a given force biasing the plates together by a relievable resilient biasing means 62.

If desired the abutments may be of other shape such as generally prism shaped and again the abutment surfaces would be similarly inclined. That is the included angle could be 70° or 90° and hence would be inclined at 55° or 45° respective to a plane normal to the axis of rotation of X-X of the clutch C.

The relievable resilient biasing means 62 in the present example, comprises a ball bearing 63 the inner race 64 of which is engaged by the driving clutch plate 54 and the outer race 65 of which is engaged by a piston 66 slidable on inner cylindrical surfaces 67, 68 of a member 69 which is carried on the outer race 70 of a second ball bearing 71 the inner race 32 of which is engaged with the driving clutch member 51. An ‘O’ ring seal R is provided between the surfaces 67, 68 and the piston 66. Alternatively, if desired, a plurality of pistons and associated cylinders may be provided circumferentially spaced around the clutch in equi-angular positions, for example four pistons and cylinders or eight pistons and cylinders.

Air is fed from a source of air under pressure (P) via a passageway 69a through the member 69 into a volume V so that when air is supplied under pressure the piston 66 is biased to the right in FIG. 5 to bias the driving clutch plate 54 towards the driven clutch plate 55 and thus to force the balls 58 into torque transmitting relationship with the abutments 60,61 on the plates 54, 55 respectively i.e. when the relieving means is de-activated. If desired any other form of relievable resilient biasing means may be provided.

A combined cage and driving member biasing assembly comprises a plurality of coil compression springs 73 provided at equi-angularly disposed dispositions around the axis X-X. If desired the springs 73 may not be equi-angular. At their right hand ends the springs 73 are housed in a blind bore 74 of a ring member 75 which engages a shoulder 76 of the member 51. At their left hand end the springs 73 are received in a blind bore 77 of a further ring member 78 which is slidably mounted on the member 51 and has an outwardly extending flange 79. The flange 79 is adapted to engage the cage plate 56 whilst an end surface 81 of the ring member 78 is adapted to engage the driving plate 54.

As a result, the cage plate 56 and the driving plate 54 are biased to the left in FIG. 5 by the springs 73. In the present example 12 springs 73 are provided circumferentially around the axis X-X and similarly a plurality, in the present example, 4 pins 85 are provided between through bores in the rings 75 and 78 for guidance purposes. The output member 52 is rotatably mounted relative to the input member 51 by a pair of ball bearings 86.

As best shown in FIGS. 5 to 7 the drive plate 55 is connected in torque transmitting relationship with a torque indicating device 101. The torque indicating device 101 comprises an outer part 122 which is ring shaped and an inner part 124 which is also ring shaped. The outer part 122 has three axially extending apertures 125 within which three bolts 121 are received to connect the outer part 122 to the output member 52. The inner part 124 is provided with six apertures 126 in which are received six bolts 100 to connect the inner part 124 to the driven plate 55.

The outer part 122 and the inner part 124 are interconnected by a pair of diametrically opposed torque transmitting element 128 which, as best shown in FIGS. 5 and 7, are relatively thin in the axial direction of the device, i.e. in a direction parallel to a central axis X-X of the device and are relatively wide in a circumferential direction, as shown in FIG. 6.

The inner and outer parts are also connected together by eight radially and longitudinally extending webs 129 which are relatively thin in the circumferential direction, as shown in FIG. 6, but are relatively wide in the axial direction, as shown in FIG. 7, and thus the webs 129 provide axial stability for the connection between the inner and outer parts 124, 122.

The torque transmitting elements 128 and the webs 129 are connected to the outer and inner parts 122, 124 by virtue of being integral therewith and so are connected thereto in an “encastré” structural mode.

As shown in FIG. 6, these parts being omitted from FIGS. 5 and 7 for clarity, an apparatus 130 for determining strain is applied to each of the torque transmitting elements 128. In the present example the apparatus 130 comprises a conventional strain gauge bridge with the strain gauges being configured so that their resistance varies in accordance with strain of the elements 128 as a result of the torque being transmitted.

The output of the apparatus 130 for determining strain is connected to a microprocessor system 131 which is connected to a transmitting aerial 133 which extends circumferentially around the outer circumference of the outer part 122 and is insulated therefrom by an insulating ring 134.

The aerial 133 comprises two generally semi-circular parts 133a, 133b which are connected to a negative terminal and a positive terminal respectively of a battery B and provide a current path into the microprocessor system 131.

The battery B is housed in a blind recess 132, of circular cross-section and extending radially relative to the axis X-X provided in the inner part 124 and in a corresponding radially extending cylindrical aperture 135 provided in the outer part 122. The battery is retained in position by the insulating ring 134 and aerial part 133a which are held in place by screws 136, 136a-b which are received in threaded inserts 137a-b which are insulated from the outer part 122.

The threaded insert 137b receives a further screw 138a which anchors a terminal tag 139a in electrically conducting relationship with the insert 137b and hence with the aerial part 133a and the tag 139a is connected by a wire 140a to a positive terminal of the microprocessor system 131. Similarly, the insert 137b receives a further screw 138b which anchors a tag 139b connected by a wire 140b to a negative terminal of the microprocessor system.

A frusto-conical spring 141 is received in the recess 132 and engages the negative terminal of the battery B. The spring 141 is connected by a further wire 140c to a terminal tag 139c which is anchored by a further screw 138c to the insert 137b.

The aerial part 133a has a further screw 142 threadedly engaged therewith, the inner end of which engages the positive terminal of the battery B. The aerial parts 133a and 133b thus provide a current path from the positive and negative terminals respectively of the battery B to the positive and negative terminals of the microprocessor system 131.

Referring now to FIG. 8, there is illustrated diagrammatically the electric circuit of the torque transmitting device.

The strain gauge means 130 comprises a conventional strain gauge bridge arrangement 144, the output of which is fed to an amplifier 45 and power is supplied on lines 146 and 147. The line 146 is connected to the positive battery terminal and provides positive supply to the amplifier 245, a single to bi-polar converter 148 and a low power radio frequency oscillator 149 which provides a transmitter which acts as a communicating means to communicate an output signal dependant upon the torque sensed by the strain gauge means. If desired a transmitter of electromagnetic radiation of other than radio frequency may be provided in association with a suitable receiver, such as a transmitter of electromagnetic radiation in the visible light or infra-red band. For example, by virtue of liquid crystal display of digits, or a suitable bar code or the like.

The output from the amplifier 145 is fed to the single to bi-polar converter 148 the output of which is fed on lines 150 and 151 to an eight bit microprocessor 152, the line 151 carrying a polarity detection or sign bit. The microprocessor 152 is connected to a negative terminal of the battery on line 154 and is also supplied with a voltage reference signal on the line 153.

The microprocessor provides a serial output on line 155 to the oscillator 149 and the oscillator 149 provides a signal on line 156 which is supplied to the aerial 133, for example on lines 140a, 140b and transmitted therefrom as a radio frequency signal. The microprocessor 152 is also connected on line 157 to the oscillator 149.

The microprocessor system comprises a central processor unit (CPU) connected to an address bus, a data bus and a control bus. The address bus is connected to a random access memory (RAM) serving as a working store, a programmable read-only memory (PROM) serving as a store for the operating program of the system and input and output buses to which the lines 150, 151, 153 and 154 are connected. In addition, the microprocessor provides a switched output to line 147 or line 157.

Referring now to FIGS. 9 and 9a, FIG. 9a is a circuit diagram in respect of the amplifier 145, the single to bi-polar converter 148, the oscillator. 149 and the microprocessor 152. The strain gauge bridge 144 is connected as shown in FIG. 9a to the terminal P₁, P₂, P₅, P₆, of the differential amplifier provided by the components within the block identified in dashed line in FIG. 9a at 145, whilst a gain setting resistor, in the form of a potentiometer, is connected to terminals P₃ and P₄. The differential amplifier 145 includes a reference voltage circuit comprising integrated circuit U4 and which also supplies the single to bi-polar converter which is provided by the components within the dashed line 148 of FIG. 9a.

The converter 148 performs an absolute value and sign detection on the output from the amplifier 145 and also conditions a signal so that it covers the full input range of the analogue to digital converter of the microprocessor provided by the components in the dashed line box 62 of FIG. 9a. The microprocessor 152 performs the analogue to digital conversion and produces a serial bit stream on line 155 to modulate the RF oscillator provided by the components in the dashed line box 149 of FIG. 9a. The absolute value signal is supplied from the converter 148 on line 150 whilst the polarity detector is supplied on line 151 in FIG. 9a.

FIG. 9 also illustrates how a battery assembly B is connected in circuit.

The RF oscillator 149 comprises a single transistor stage using a crystal element operating in fundamental mode. Since the whole circuit must be operated at very low power levels so as to give a long battery life, for example six months, and since there is no requirement for range, no power amplification stage is necessary or desirable. Only sufficient radio frequency power is developed in order to fully drive a receiver at a distance of, for example, 25 mm or less away from the aerial.

The aerial 133 is directly loosely coupled into the oscillator collector circuit by a transformer coupling comprising, for example, four turns of wire 133a around an inductor, the other end being connected to the metalwork of the sensor assembly which is grounded or forms a counterpoise through the bulk of the apparatus with which the device is used. This increases the radiated radio frequency power considerably. Narrow band frequency modulation is achieved by changing the DC bias point and hence the parasitic capacitances in the base/emitter and collector/base circuits. The frequency change is approximately ±100 hertz from a nominal mean centre frequency, which is itself correctly adjusted with a small variable capacitor across the crystal. If desired, the frequency change may of be other value such as ±500 hz from said nominal mean centre frequency.

The receiver R is of any suitable kind, for example, a simple “data sheet”, single conversion superhet design using, for example, an MC3361 chip. A fundamental crystal is used to give 455 kilohertz IF. The output from the FM modulator is AC coupled with a comparator which drives the output at TTL levels. The squelch circuit operates at high HF noise to clamp the input to the comparator and the desired information can be presented as described hereinafter.

The microprocessor controls the operation according to the program in PROM. Referring to the flow chart of FIG. 10, the operation is as follows:—

The clock of the microprocessor initially switches power on to lines a and b. The microprocessor then receives signals of the absolute value of the torque on line 150 in analogue form from the single to bi-polar converter 148 and the power on line 147 is then switched off.

The microprocessor performs an analogue to digital conversion and eight bit serialises the torque value and ascribes a sign in accordance with the polarity detector signal supplied on line 151. The microprocessor then digitises the input from the voltage reference and eight bit serialises this information. The microprocessor compares the torque value with full scale output of the A/D stage and if the torque is less than 5% of this the microprocessor switches the power off on line b and the system remains in this condition until the microprocessor clock reaches the end of a pre-programmed sleep mode which lies in the range 50 to 1000 milliseconds, in the present example 5 hertz. Thereafter the microprocessor switches power on at lines 147 and 157 and the cycle is repeated as previously described. The bridge is provided with a scaling resistor 158 which can be adjusted to give a full scale output of the A/D converter stage for a predetermined torque.

Alternatively, if the torque comparison indicates that the torque is not less than 5%, the power on line 157 is maintained and after a short delay, which typically lies in the range 150 milliseconds, and in the present example is 100 hertz, the cycle is repeated by the switching of power on to both lines 147 and 157.

The circuit is powered, in the present example, by the battery B which comprises a lithium thionyl chloride battery of 1500 mAh capacity. The battery provides a d.c. current at a voltage lying in the range 3.3-3.7 volts. This voltage is determined by the reciprocal of the digitised VREF, since all A/D conversions are ratiometric.

When the torque is less than a predetermined value then, as explained above, the circuit is arranged to sample the torque at a relatively low frequency. In the present example 5 hertz. However, when, as a result of such a sampling, the torque is detected to be greater than the predetermined value a higher sample and transmission rate is signalled to occur, in the present example 100 hertz. As a result, because the circuit is not sampling and transmitting a signal continuously, the power consumption of the device is relatively small compared with consumption which would be the case if the sampling were performed continuously.

In the present example the signal is a frequency modulated signal at a nominal frequency of 27.145 MHz.

The radiated signal is detected by a receiver R located adjacent the aerial 133, in the present example 5 mm apart but which may lie preferably in the range 2 mm to 10 mm, for example, up to 25 mm apart. The receiver R is supplied with power on line R₁ and is arranged to display the detected torque and, if desired, power and/or battery state, in any desired manner. If desired the receiver may provide a signal to a printer to provide a permanent record and/or to a computer system or other device. If desired the circuit illustrated and described hereinbefore may be modified as illustrated in FIG. 10a in which power is supplied to a regulator R which supplies an output of 0 and +5 volts. This output from the regulator R is then supplied to the various stages of the circuit as illustrated in FIG. 10a in which the same reference numerals are used to refer to corresponding parts as were used in the previous figures, except that the single to bi-polar converter 48 is not used. If desired the component 48 may be provided where it is desirable for reasons of resolution.

If desired, the A/D and the microcompressor may be both of 8 bit type or alternatively the microcompressor may be of 8 bit type and the A/D of 10 bit type and the 10 bit A/D may be provided off-board or on-board as desired.

As can be seen from FIG. 10A, if desired, an interface I to a slip-ring assembly may be provided instead of a low power oscillator 49. Such an arrangement is utilised in the slip-ring version of the device illustrated in FIG. 12.

FIG. 11 shows an alternative configuration of coupling to that shown in FIG. 5 in which the same reference numerals are used to refer to corresponding parts as are used in FIG. 5. The electric circuitry and components as well as the manner of operation are the same as hereinbefore described with reference to FIG. 5 modified as necessary mutatis mutandis.

If desired, instead of an electromagnetic communication apparatus as described hereinbefore the signal dependent upon said transmitted torque, may be transmitted to a receiving apparatus by providing a slip ring between the torque transmitting device and a fixed element or ground. FIG. 12 shows a coupling embodying the present invention in which a slip ring is shown at 200 and a pick-up at 201. The torque sensing apparatus is provided on torque transmitting element 202 and either the analogue signal resulting from the torque sensing apparatuses may be fed via the slip ring to a stationary position at which the analogue signal is operated upon by electronics functioning in the same manner as described hereinbefore or by conventional signal processing equipment (for example an analogue meter) or, if desired, the analogue signals from the torque sensing apparatuses may be processed in a similar manner to that described hereinbefore and the processed signal which in the example described hereinbefore is fed to an electromagnetic transmitter is, in the embodiment shown in FIG. 12, fed to the slip ring 200 and the processed signal is picked up by the pick up 201.

Alternatively or in addition, the sensitivity of the torque transmitting means may be adapted by altering the configuration of the torque transmitting means.

In use, when the driving member 51 is rotated through the shaft 41a by the motor 43a then so long as torque is to be transmitted to the driven clutch member 55 and thence to the torque indicating device 101 the relieving apparatus is de-activated so that air under pressure is supplied to the volume V to bias the plates 54, 55 towards each other and so long as the torque to be transmitted is lower than a predetermined torque then the torque is transmitted between the clutch members 54, 55 by the balls 58 and torque transmitting abutments 60, 61.

If the torque to be transmitted increases above a predetermined torque the balls 58 begin to roll out of their associated abutments 60, 61 as the force applied by the piston 66 is less than the resultant force tending to bias the driving plate 54 to the left in FIG. 5.

As the driving plate 54 is forced to the left away from the driven plate 55 the piston 66 is pushed to the left in FIG. 5 and this causes a relieving means actuating disc 86 to engage a sensor of a relieving apparatus shown at 87, such as a micro-switch, to open an electrically operated valve in the supply of air to the passage 69a so that the air supply is cut off and the pressure within the volume V is released thereby relieving the resilient bias of the driving plate 54 to the right in FIG. 5. In this condition the relieving apparatus is activated. In addition, as the balls 58 ride out of their associated abutments they rotate and cause the cage plate 56 to rotate at half the relative speed between the driving and driven clutch plates relative to each clutch plate. Because of the above described configuration of the apertures 57 and their relationship with the size of the balls 58 the cage plate 56 is also moved to the left of the figure away from the driven clutch plate 56.

When the pressure in the volume V is relieved as described hereinbefore the coil springs 73 bias the driving clutch plate 54 and the cage plate 56 to the left in FIG. 5.

As the driving and driven members continue to rotate relative to one another the balls 58 continue to rotate until they become circumferentially aligned with the next adjacent torque transmitting abutments. When the balls are thus aligned springs 73 urge the cage plate 56 to the left which movement is permitted by the alignment of the balls 58 with the torque transmitting abutment 60 in the driving clutch plate 54 and thus the cage plate guides the balls 58 into the abutment and maintains the balls therein whilst the driving clutch plate 54 continues to rotate relative to the driven clutch plate 55. The cage plate 56 thus maintains the balls 58 out of position for engagement with the abutments 61 of the driven clutch plate 55 so that relative rotation between the driven and driving clutch plates can continue without any risk of the balls chattering as the result of engagement with the abutments 61.

Reengagement is achieved simply by applying air pressure to the piston 66 so that the abutments 61 in the driven clutch plate 55 are moved into torque transmitting engagement with the balls 58 when they become suitably aligned therewith as a result of the relative rotation between the driving and driven clutch members.

The predetermined torque at which the clutch disengages can be easily adjusted by varying the pressure of the air acting on the piston 66. The relieving means may be arranged to relieve the relievable resilient biasing means when the driven clutch plate 20 has moved through an axial distance somewhat less than that required completely to disengage the balls 58 from the recesses 60, 61 but complete disengagement is achieved by the hereinbefore described springs 73 when the biasing means is relieved.

Although the clutch described hereinbefore has been described in its function as a torque limiting clutch, if desired it may be used as simple clutch either under the control of an operator or under the control of automatic operating means in dependence on the torque indicated by the torque indicating device 101 described above. In such a case drive is transmitted when air under pressure is supplied to the relevant volume V and drive is disconnected when the air supply to the relevant volume V is relieved by an appropriate mechanism in the air supply means.

In the previously described couplings 40/40a air under pressure is applied to the volume V to bias the plates 54 and 55 towards each other and so enable torque to be transmitted between the plates by the balls 58, or other rolling elements, and the recesses 60 and 61.

Referring now to FIG. 13, a further alternative coupling 40/40a to that shown in FIG. 5 is illustrated in which the same reference numerals are used for corresponding parts as are used in FIG. 5. In this embodiment a clutch plate 354 is axially slidably and non-rotatably mounted on a drive member 51.

The plate 354 has a plurality of circumferentially disposed pins 356 which are held in torque transmitting relationship with detents 361 provided in a driven clutch plate 355 by a plurality of coil compression springs 300.

In this embodiment the pins 356 and the detents 361 have mutually engaging surfaces of frusto-conical configuration having a cone angle such that the clutch will disengage when a predetermined torque is exceeded so that in this the clutch will act as a torque-limiting clutch.

If desired, in a modification, an alternative angle may be used such that the clutch will stay in engagement with any positive spring pressure or applied torque.

In either case rolling elements such as balls and recesses may be used instead of pins and detents as in the previously described embodiments. The angle of the recesses are chosen in relation to the rolling element diameter to provide either a torque-limiting clutch or not.

In this embodiment, or the modification thereof described above, a pneumatic system is provided to overcome the load applied by the springs 300 to the clutch plate 354. This comprises a sleeve 301 which is axially immovably mounted on the clutch plate 355 by means of a ball bearing 302 and is prevented from rotation by a suitable anti-rotation device attached to the sleeve 301 at the point shown at 311 and as desired at other corresponding points. Axially slidably mounted on the sleeve 301 is a flange member 303 which is made an air-tight fit by means of O-ring seals 304a, 304b. Thus a sealed volume 305 is formed between the flange part 303 and a transversely extending limb 306 of, or attached to, the sleeve part 301.

Air under pressure may be introduced into the volume 305 via an air port 307.

When air under pressure is introduced into the volume 305 an axial load is applied to a flange part 308 of the flange member 303 to cause it to apply an axial load to a plate 309 through a bearing 310 which allows the clutch to rotate relative to the parts 303 and 301. The plate 309 is connected to the clutch plate 354 by, for example, a split ring 311.

If the thus applied axial load exceeds the load applied by the springs 300, the plate 309 moves the clutch plate 354 to disengage the clutch by disengaging the pins 356 from the detents 361.

In a modification of this embodiment, the coupling 40a may act as a holding brake. In FIG. 13, when the clutch plate 54 is in its disengaged position, the left hand face 354a of the clutch plate 354 is spaced from the limb 306. If desired, for example by removing an abutment part 354b, the clutch plate 354 may abut the limb 306 in its disengaged position to prevent co-rotation thereof and such that the coupling 40a acts as a holding brake. Metal-to-metal contact between the surface 354a and the limb 306 may provide sufficient frictional contact, or alternatively a suitable surface may be provided on one or both of the surface 354a and limb 306 as desired.

In other respects the embodiment described with reference to FIG. 13 is similar to the other embodiments and so further discussion is not required.

If it is desired to operate the clutch automatically in accordance with the torque sensed by the device, the apparatus, which in the present example is the apparatus described with reference to FIG. 13 is provided with additional components as shown in FIG. 14. The device illustrated in FIG. 14 the same as that illustrated in FIG. 13; as is its manner of operation and the same reference numerals have been used in FIG. 14 as were used in FIG. 13.

The torque sensing device has a receiver 400 which receives a signal dependent upon torque transmitted by the device through the aerial 33.

The receiver 400 provides a signal on a line 401 which is proportional to the torque sensed and this signal is fed to an output device 402. The output device 402 provides a relay output when the torque sensed by the device achieves a predetermined torque level set in the output device 402. The relay output is fed on line 403 to a plant controller 404 which provides an output signal on a line 405 to switch a solenoid or other valve 406. The solenoid valve 406, is of conventional type and can either connect the inlet 307 to an air supply under pressure P as indicated by the line 407 or to exhaust by the line 408.

In use, when the torque exceeds the predetermined level set in the output device 402 a relay out put is fed on lines 403 and 405 to the air solenoid valve 406 to cause air under pressure to be fed to the inlet 307 to cause the clutch to be disengaged as described hereinbefore in connection with FIG. 13. It is desired to reengage the clutch a signal is fed to the air solenoid valve 406 to cause it to connect the inlet 307 to atmosphere instead of to supply air under pressure P on line 407.

Of course similar arrangements may be provided as desired with other embodiments such as the embodiment shown in FIG. 5 where in this case a solenoid valve is arranged to connect the inlet 69a to exhaust when the torque exceeds a predetermined value.

In all the embodiments, to enable display of power, a reflective target T is provided at one position, or at a plurality of circumferentially spaced positions on the outer parts 122, or on any other convenient rotating component of the device. Passage of the target T past a photo electric cell P is detected and the time taken for a complete revolution is thus measured to provide the speed of rotation of the device. The torque transmitted is multiplied by the thus determined speed to enable power transmitted by the device to be displayed.

The conveyor lift described hereinbefore therefore is capable of operation in a plurality of different modes. In the illustrated example the conveyor lift is provided with a main drive motor and an auxiliary drive motor with associated drives but, if desired, the conveyor lift may be provided with only a single drive motor and associated drive.

Further, whether a single drive or a pair of drives is provided, the clutch described hereinbefore may function as a torque limiting clutch or clutches or the pressure of air supplied to the volume V, in association with the other element parameters of the clutch, may be such that the or each clutch may not function as a torque limiting clutch.

Whether the or each clutch operates as a torque limiting clutch or not, the or each clutch is provided with relieving means which can be de-actuated so as to enable torque to be transmitted by the clutch or actuated so as interrupt transmission of torque.

A conveyor lift in accordance with the present invention enables the drive to be manually controlled so as to either drive or not drive as desired and therefore a change from the main drive motor to the auxiliary drive motor and vice versa can be made simply by actuating the relieving apparatus of the coupling where drive is required to be transmitted and de-activating the relieving apparatus of the coupling where drive is not required.

This may be done manually or automatically, for example, on the basis of the time for which a drive has been operating. Alternatively, any attainment of a predetermined torque, for example, the occurrence of an abnormal torque level, is indicated by the torque sensing apparatus and then if desired, where an alternative drive is provided, the coupling may be arranged to changeover the drive from the main drive motor to the auxiliary drive motor or vice versa at a predetermined torque value this may be done manually or automatically.

In addition or alternatively a signal may be provided so that a maintenance operative may investigate the drive showing an abnormal torque before failure thereof and/or if desired before changeover to the other motor.

The couplings may be arranged so that the drive motors are operated alternatively without losing any time in the changeover.

If desired the condition of the drive and/or of the lift may be monitored by sensing a predetermined torque or a predetermined variation in torque using the torque sensing apparatus.

A user, such as a maintenance operative, may record a predetermined torque or a predetermined variation in torque in any desired manner by using the output from the torque sensing apparatus.

If an undesirable increase in torque occurs, then the drive is protected against this by the provision of the above mentioned coupling as a torque limiting coupling. If desired the torque indicating device may be disposed at a different location in the drive part from the motor to the sprockets 16 to that illustrated in FIG. 4.

A more detailed description and of various modifications of the torque limiting clutch and of the torque indicating apparatus described hereinbefore are contained in our European patent EP 0310020 B1 and British patent GB 2286055 B respectively the contents of which are incorporated herein by reference.

If desired, the clutch part of the coupling described hereinbefore may comprise any other suitable form of clutch and for example it may be a clutch which is engaged by springs and disengaged by the application of air or the clutch may be a pin clutch in which pins are axially moveable into inter engagement with sockets to transmit torque or may be a spring clutch or an electromagnetic clutch.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A conveyor lift having a device for engaging a product to transfer the product from a conveyor at one level to a conveyor at another level wherein the lift is driven by at least one drive comprising a motor, and a coupling to couple the motor to the motor wherein the coupling comprises a clutch comprising a pair of drive members which are relatively rotatable about, and axially movable along, an axis; a relievable biasing device to bias the drive members axially towards each other so as to be disengageably connected in torque transmitting relationship and a relieving apparatus operable to release the biasing device to interrupt transmission of said torque and the coupling also incorporating a torque indicating device comprising first and second torque transmitting parts, torque transmitting elements connecting said first and second parts, the device being rotatable about the axis and having torque sensing apparatus on at least one of said torque transmitting elements and responsive to torque transmitted by said torque transmitting element to provide a signal dependent upon said transmitted torque.

2. A conveyor lift according to claim 1 where said signal is transmitted to a receiving apparatus by means of a slip ring between the torque indicating device and a fixed element.

3. A conveyor lift according to claim 1 wherein the torque transmitting device is provided with a communicating apparatus including a transmitter of electromagnetic radiation receiving said signal produced by said torque sensing apparatus and communicating an output signal dependent upon said torque to receiving apparatus which provides an output responsive to said transmitted torque.

4. A conveyor lift according to any of the preceding claims wherein the first part of the torque indicating device comprises a radially inner part, relative to said axis, and the second part comprises a radially outer part, relative to said axis and the torque transmitting elements comprise at least one radially and circumferentially extending torque transmitting element extending between said parts to transmit torque therebetween.

5. A device according to claim 1, claim 3 or claim 4 when dependant on claim 3 wherein the electromagnetic radiation is of radio frequency and is transmitted from an aerial to the receiving means.

6. A device according to any one of the preceding claims wherein the drive members are disengageably connectable in torque transmitting relationship by a plurality of torque transmitting elements interposed between the drive members and which are biased into torque transmitting relationship with torque transmitting abutments by the biasing means when the clutch is engaged and which are moveable out of torque transmitting relationship with a torque transmitting abutments.

7. A device according to claim 6 wherein the torque transmitting elements of the clutch are rotatable and are guided by a cage which is free to rotate relative to both drive members during disengagement and there are provided:
a) means to maintain the cage space further from one of said drive members when the clutch is disengaged than when the clutch is engaged, and
b) a guide member biasing means to remove the guide members apart when the clutch is disengaged to provide a separation between the parts of the drive members which are engaged by the torque transmitting elements which is greater than the diameter of the torque transmitting elements
to maintain the torque transmitting elements out of engagement with the torque transmitting abutment of said one drive member when the clutch is disengaged.

8. A clutch according to any one of the preceding claims wherein the clutch is a torque limiting clutch and said movement of the torque transmitting elements out of out torque transmitting relationship occurs when the torque exceeds a predetermined value and is as a result of movement of the drive members axially apart by the torque transmitting elements and the relieving means relieves the biasing means when the torque exceeds the predetermined value.

9. A conveyor lift according to any one of claims 1 to 8 having control means for managing the relief of said biasing device or devices based on transmitted torque.

10. A conveyor lift according to any one of the preceding claims wherein the lift is provided with a main drive and an auxiliary drive each of which comprises a motor and a coupling to couple the motor to the lift.

11. A conveyor lift according to claim 10 wherein the main drive and the auxiliary drive are each in accordance with any one of claims 1 to 9.

12. A conveyor lift according to claim 10 or claim 11 wherein the relieving means of one of said clutches is actuated to cause the clutch not to transmit torque when the torque indicating device of the coupling comprising said one clutch senses a predetermined torque and the relieving means of the other of said clutches is de-activated to cause said other clutch to transmit torque.

13. A conveyor lift according to claim 10 or claim 11 wherein a control apparatus is provided alternately to activate one of said drives to cause it not to transmit torque to the lift and de-activate the other of said drives to cause it to transmit torque to the lift.

14. A conveyor lift according to claim 13 wherein the control apparatus is manually operable.

15. A conveyor lift according to claim 13 wherein the control apparatus is automatically operated on the basis of the time for which each of said drives has been activated.

16. A conveyor lift according to any one of the preceding claims wherein the biasing means comprises air pressure means and the relieving means comprises means to relieve said air pressure.

17. A conveyor lift according to any one of claims 1 to 7, or 8 to 15 when dependent on any one of claims 1 to 7, wherein the biasing means comprises a spring means and the relieving means comprises air pressure means.

18. A conveyor lift substantially as hereinbefore described with reference to the accompanying drawings.

19. A method of operating a conveyor lift according to claim 1 comprising performing a step selected from the group comprising:
a) wherein the clutch is a torque limiting clutch and relative movement of said drive members when the transmitted torque exceeds a predetermined value causes operation of the said relieving apparatus,
b) wherein the conveyor lift is provided with a main drive and an auxiliary drive each of which comprises a motor and a coupling to couple the motor to the lift wherein a control device is provided wherein the relieving apparatus of one of said clutches is actuated to cause the clutch not to transmit torque when the torque indicating device of the coupling comprising said one clutch senses a predetermined torque and the relieving apparatus of the other of said clutches is de-activated to cause said other clutch to transmit torque,
c) wherein the lift is provided with a main drive and an auxiliary drive each of which comprises a motor and a coupling to couple the motor to a lift and said control device is operated alternately to de-activate one of said relieving apparatus to cause it to transmit torque to the lift and to de-activate the other of said relieving apparatus to cause it not to transmit torque to the lift,
d) the control device referred in c) is a manually operable device or is operable depending upon the time for which each drive has been operating or may be operable depending on the time for which each drive has been operating.
e) a predetermined torque may be indicated by the torque indicating apparatus,
f) where the lift is provided with a main drive an auxiliary drive each of which comprises a motor and a coupling to couple the motor to the drive the coupling may be arranged to changeover the drive from the main drive motor to the auxiliary drive motor or vice versa at a predetermined torque,
g) the torque indicating device may provide a signal in accordance with a predetermined torque so that a maintenance operative may investigate the drive showing said predetermined torque and may cause a changeover of the drive from said one drive to the other drive.
h) apparatus may be provided to monitor the condition of the or each drive and/or of the lift by sensing a variation in torque.
i) apparatus may be provided to record the variation in torque of the or each drive in any desired manner using the output of the torque indicating device.

20. A method substantially as hereinbefore described with reference to the accompanying drawings.

21. Any novel feature or novel combination of features described herein and/or shown in the accompanying drawings.
